(19) United States
(12) Patent Application Publication
(10) Pub. No.: US 2002/0130095 A1
(43) Pub. Date: Sep. 19, 2002

(54) Retail space utilization method

(76) Inventor: Robert E. Rinner JR., Broken Arrow, OK (US)

Correspondence Address: THOMPSON COBURN, LLP, ONE FIRSTAR PLAZA, SUITE 3500, ST LOUIS, MO, 63101, US

(21) Appl. No.: 09/802,501

(22) Filed: Mar. 9, 2001

(51) Int. Cl. B42F 1/00

(52) U.S. Cl. 211/50

(57) ABSTRACT

The invention is a method of and apparatus for utilizing under-conveyor space such as a retail grocery conveyor comprising measuring a height and a width of an under-conveyer space and dimensioning a display rack to fit within said under conveyor height and width.

### CROSS-REFRENCE TO RELATED APPLICATIONS

None.

### STATEMENT REGARDING FEDERALLY SPONSORED RESEARCH OR DEVELOPMENT.

Not Applicable.

### BACKGROUND OF THE INVENTION

1. Field of the Invention

This invention relates generally to a merchandising and retail space utilization method for using otherwise unused under-counter space in retail checkout lines.

2. Related Art

Retail merchandising practices place a premium on the value of shelf space. The amount, placement and visibility of displays are directly proportional to the sales performance of merchandise shelved or advertised at given locations. Maximizing the display and advertising potential of available space in retail stores such as discount department stores and grocery stores is known to lead to increased sales and profit margins for those stores and for the purveyors of the merchandise sold within them.

The retail merchandising arts are well developed in matters of pricing amounts of shelf space to be allocated to certain products for merchandising those products in a retail outlet such as a grocery store. Further, retail marketing practices are well developed in matters of placing the advertisement and display of certain merchandise at various positions throughout retail merchandiser's store. These techniques are used to emphasize or de-emphasize the marketing and sales of various items of merchandise. Moreover, it is known that certain merchandise is more profitably targeted towards “impulse” buying, such as magazines or candy, whereas sales of more staple items are less responsive to placement.

It is further known that certain store areas have a more concentrated value for promoting, displaying and advertising certain items. High traffic areas and areas that must be traversed by the shopper have the highest value. In the environment of a grocery store or discount department store, the checkout counters constitute a space with high display and advertising value.

The checkout counter space value is multiplied when that space is used in combination with the merchandising of impulse sale items. Moreover, it is known that checkout counters are frequently crowded. Consequently, customers are spending idle time there which further increases the value of advertising and display space visible from the point of view of a customer waiting in a checkout line.

Standard space utilization techniques at checkout counters organize the presence of certain necessary checkout components in relation to checkout traffic. Generally, a store clerk and cash register are on one side of a work space, and the customer on the other. The work space can be a shelf or platform for placement of items being purchased and cash, checks or credit or debit cards for payment. It is also typical for a bar code scanner to be incorporated into such a work shelf or platform. Progress of items to be purchased across the work platform is typically handled by means of a conveyor belt leading up to the work station. After items have been scanned, there is typically a counter where items to be purchased collect and are thereafter bagged. If a conveyor belt is not used to introduce items to the work platform scanning station, there is still frequently an extension of a shelf or platform extending towards the next customer in line from the work station. In this fashion, checkout speed is increased by providing a conveyor belt or shelf extension on which the next customer in line may place their items to be purchased while the previous customer is paying for their purchases.

In most checkout layouts the conveyor belt or platform extending towards the next customer rests on a platform. In most circumstances the conveyor belt or shelf extends in the direction of the waiting customers for a distance beyond its supporting platform. Thus, there is an overhang between the leading edge of the conveyor belt and the floor. This overhang defines a space typically from about the waist level of the waiting customer and down to the floor. This space is as wide as the conveyor belt.

The space under the counter at checkout lines in grocery stores, discount department stores and other retail merchandising stores is not utilized in the prior art. Display, advertising, merchandising and sales would benefit from an invention allowing the utilization of this space.

### SUMMARY OF THE INVENTION

It is in view of the above utilization concerns for display, advertising and merchandising that the present invention was developed. The invention is a method and apparatus for maximizing utilization of store space near checkout counters. The method involves first measuring the under-counter space at the checkout line, in order that the height and width of the unused space are known. The method further comprises dimensioning a display apparatus, such as a rack, to fit within the available height and width under the checkout counter. The method further comprises dimensioning and supporting advertisement space to appear beneath the checkout counter conveyor belt. The method may further comprise ergonomic calculations, such as angling the face of the display and/or advertisement to be perpendicular to the line of view of customers waiting in checkout line, which will usually mean tilting it upwards.

Further features and advantages of the present invention, as well as the structure and operation of various embodiments of the present invention are described in detail below with reference to the accompanying drawings.

### BRIEF DESCRIPTION OF THE DRAWINGS

FIG. 1 is a side view of a display rack and advertising placard utilizing the present invention.

FIG. 2 is a front view of a display rack and advertising banner utilizing the present invention.

### DETAILED DESCRIPTION OF THE PREFERRED EMBODIMENTS

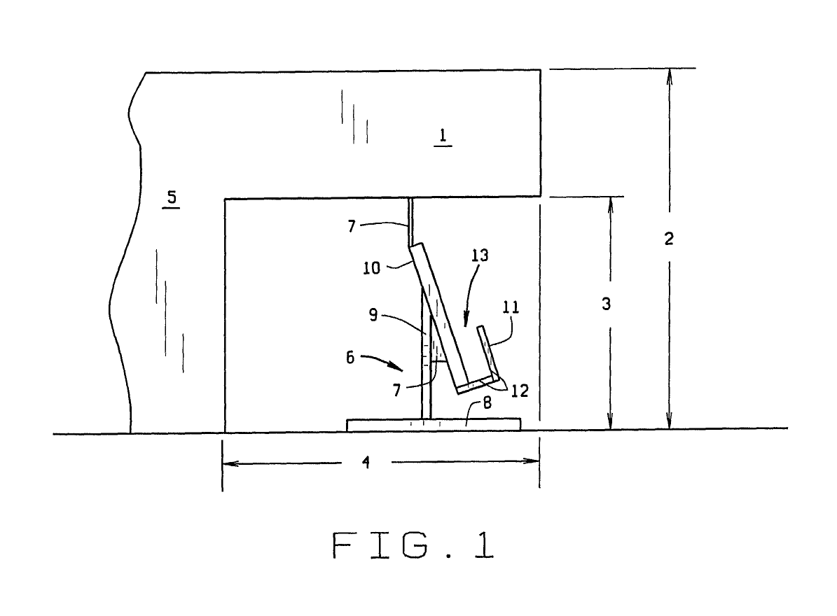

Referring to the accompanying drawings in which like reference numbers indicate like elements, FIG. 1 is a side view of a display apparatus utilizing the method of the present invention. Checkout counter conveyor belt, 1, has a first height dimension from the floor to the top of the conveyor belt, 2, and second height dimension from the floor to the bottom of the conveyor belt, 3. Checkout counter conveyor belt 1 has a horizontal dimension, 4, from the end of the checkout counter conveyor belt to the conveyor belt support platform, 5. These dimensions, together with the width of the checkout counter conveyor belt (not shown) constitute the potential advertising/display/merchandising space not utilized in the prior art.

The method of the present invention is to determine the under-counter dimensions, including the height dimension, 3, and the width dimension. Thereafter an advertising/display apparatus, 6, is manufactured according to those dimensions.

The advertising/display apparatus, 6, may be configured to accommodate display of merchandise including, but not limited to, magazines, candy bars and other incidentals. In the preferred embodiment, the face of this display would be non-vertical. The angle from vertical, 7, is configured to make viewing the displayed items readily convenient for customers waiting in line.

The advertising /display apparatus, 6, has a base, 8 vertical support member(s) 9, and advertising/merchandise support structure, 10.

There will exist on the apparatus of the present invention, deployed according to the method of the current invention, at least one and potentially two or more spaces usable for display. A top space, 7, may not be filled with items for display because typical display racks require an empty vertical space through which a customer may lift a displayed item from the display rack in order to purchase it. According to the space utilization method of the present invention, this space, 7, is available for advertising. A second space, 11, will exist at the bottom of the display apparatus of the present invention, and be coextensive with the panel or wires or other means, 12, used to retain magazines or other merchandise in the display rack. Merchandise or further advertising may be displayed in the space, 13, between spaces 7 and 11.

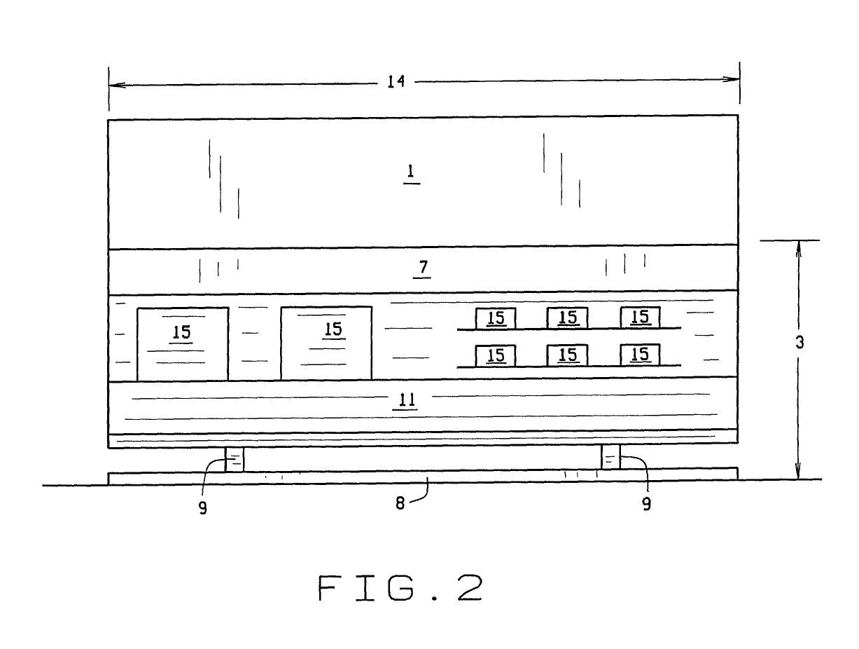

FIG. 2 is a front view of the under-counter space as utilized by the method and apparatus of the present invention. Counter, 1, has an under-counter vertical dimension, 3, and a width, 14. The display/advertising apparatus of the present invention, 6, is dimensioned to maximize utilization of this under-counter space facing customers waiting in the checkout line. Advertising banner space, 7 and 11, also face the customer in a visible fashion to further utilize the space to its maximum potential. Merchandise 15 or further advertising may be displayed in the space between advertising spaces 7 and 11.

By increasing the utilization of space that was unused in the prior art, the apparatus and method of the present invention increase store revenues because the store will charge merchandisers for use of the display and/or advertising space afforded by the present invention. Further, the present invention will increase sales, income and profits for merchandisers displaying their products in the previously unused space and/or advertising their products in the previously unused space.

In view of the forgoing, it will be seen that these several advantages of the invention are achieved and attained.

The embodiments were chosen and described in order to best explain the principles of the invention and its practical application to thereby enable others skilled in the art to best utilize the invention and various embodiments with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

What is claimed is:

1. A method of utilizing under-counter space comprising:
measuring a height and a width of an under-conveyer space;
dimensioning a display rack to fit within said under conveyor height and width; and
displaying a quantity of merchandise on said rack in said space.

2. The method of claim 1 wherein said measuring step is performed on at least one advertisement and said displaying step is performed with said advertisement.

3. The method of claim 1 further comprising angling said display rack to be substantially about perpendicular with a line of sight of a customer.

4. The method of claim 2 further comprising angling said advertisement to be substantially about perpendicular with a line of sight of a customer.

5. The method of claim 1 further comprising displaying at least one advertisement adjacent to a quantity of merchandise on said display rack.

6. The method of claim 3 further comprising displaying at least one advertisement adjacent to a quantity of merchandise on said display rack.

7. A merchandising apparatus comprising
a base;
a display rack mounted on said base, for displaying a quantity of merchandise, said rack being dimensioned to fit under an under-conveyor space height and said rack being further dimensioned to fit within an under-conveyor space width.

8. The apparatus of claim 7 further comprising at least one advertisement.

9. The apparatus of claim 7 wherein said display rack is angled to be substantially about perpendicular to a line of sight of a customer.

10. The apparatus of claim 8 wherein said display rack and said at least one advertisement are angled to be substantially about perpendicular with a line of sight of a customer.

11. An advertising apparatus comprising:
a base;
at least one advertising surface mounted on said base, said apparatus being dimensioned to fit under an under-conveyor space height and said apparatus being dimensioned to fit within an under-conveyor space width.

12. The apparatus of claim 11 wherein said advertising surface is angled to be substantially about perpendicular with a line of sight of a customer.
